(19) United States
(12) Patent Application Publication
(10) Pub. No.: US 2012/0109738 A1
(43) Pub. Date: May 3, 2012

(54) TESTING ON-LINE ADVERTISING

(75) Inventor: Peng Han, Lynnwood, WA (US)

(73) Assignee: Microsoft Corporation, Redmond, WA (US)

(21) Appl. No.: 12/914,989

(22) Filed: Oct. 28, 2010

(51) Int. Cl. G06Q 30/00

(52) U.S. Cl. 705/14.41

(57) ABSTRACT

The claimed subject matter provides a method for testing on-line advertising. An exemplary method comprises determining a need for test for an advertising campaign based on performance of the advertising campaign. The exemplary method also includes determining whether the need for test exceeds a predetermined threshold. Additionally, the exemplary method includes allocating a test impression to a buy control placement of the advertising campaign based on the need for test.

### BACKGROUND

A problem faced by many advertising networks in conducting advertising campaigns is the need to learn how ads perform in terms of click through rate, conversion rate or the like to predict future performance. Predicting future performance may facilitate allocating advertising inventory such that the revenue, or advertiser return on investment, is maximized.

Such learning is often accomplished by collecting statistics during an audit budget period. Statistics collected within this budget period may be analyzed to determine how well an advertising campaign performs on different inventory segments. Inventory segments may represent different categorizations of available advertising inventory. The categorization can be defined in terms of different populations, visited web sites, or even demographically.

A random allocation of advertising campaigns often incurs an opportunity cost for advertising networks. This opportunity cost represents a loss in advertising-generated revenue because the advertising is not targeted to its preferred audience or optimized.

Given that many performance campaigns, especially cost per action campaigns, typically have low conversion rates, the amount of collected information that represents a statistical significance is often substantial. As such, the audit budget period may be large.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for testing on-line advertising. A need for testing an advertising campaign may be determined based on performance of the buy control placements within the advertising campaign. If the need for test exceeds a predetermined threshold, test impressions may be allocated to the buy control placements based on the need for test.

In an exemplary method, the need for test may be based on a data sufficiency of the advertising campaign, a data sufficiency of a plurality of buy control placements of the advertising campaign, an amount of remaining budget of the advertising campaign, and an amount of remaining days of the advertising campaign. The need for test may be a numeric value between 0 and 1 inclusively that indicates the strength of need for getting test impressions to gain data sufficiency. A need for test value of 0 indicates that there is not a need to test the advertising campaign. A need for test value of 1 indicates that there is a strong need to test the advertising campaign.

An exemplary system tests an on-line advertising campaign by determining whether the on-line advertising campaign is to be tested, and allocating test impressions to the buy control placements within a budget. The test impressions are allocated in ascending order of the test opportunity cost of the buy control placements to minimize revenue impact to the advertising network.

Another exemplary embodiment of the subject innovation provides a non-transitory computer-readable medium that includes code to direct the operation of a processing unit. The code may direct the processing unit to test an on-line advertising campaign by determining whether to test the campaign, and allocating test impressions to buy control placements within a budget. In one exemplary embodiment, an impression cap may be determined for the number of test impressions that are allocated. A budget cap may also be determined for allocating the test impressions.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a system for automatic testing of advertising campaign performance in accordance with the claimed subject matter;

FIG. 2 is a process flow diagram of a method for automatic testing of advertising campaign performance in accordance with the claimed subject matter;

FIG. 3 is a process flow diagram for allocating test impressions to buy control placements in accordance with the claimed subject matter;

FIG. 4 is a block diagram of an exemplary networking environment wherein aspects of the claimed subject matter can be employed; and

FIG. 5 is a block diagram of an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “engine,” “manipulator” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media. Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

A large audit budget period for advertising may discourage small to middle size advertisers, and hence hinder the growth of advertising network business. Additionally, existing campaigns may gradually lose data sufficiency on certain inventory segments. As such, existing campaigns may benefit from re-testing of the inventory segments. However, the re-testing is typically difficult and resource intensive. The subject innovation relates to providing more effective allocation of advertising inventory such that advertisers can start their campaigns without committing to an upfront audit budget, and existing campaigns can maintain their data sufficiency in an automated fashion.

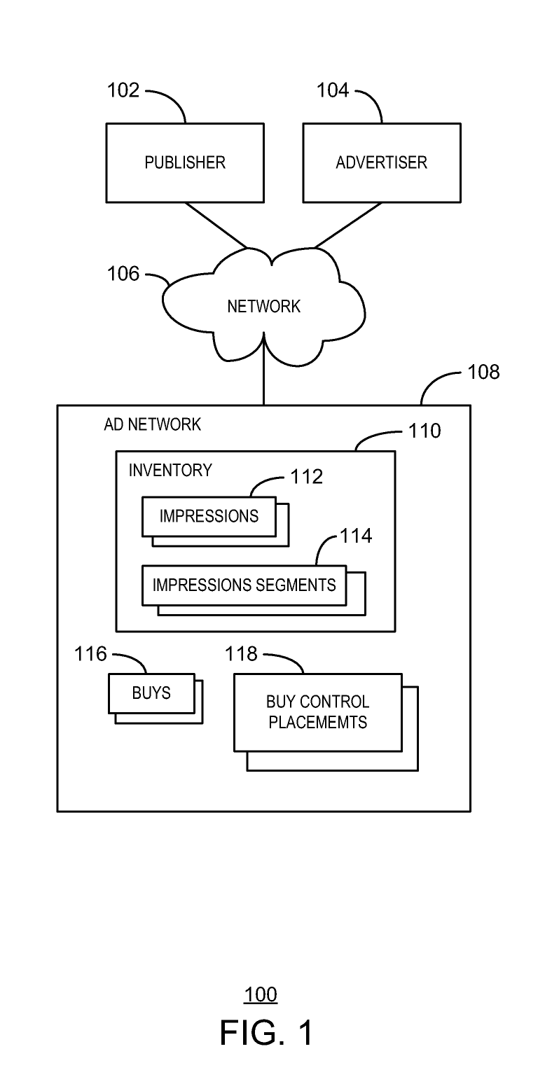

FIG. 1 is a block diagram of a system 100 for automatic testing of advertising campaign performance in accordance with the claimed subject matter. The system 100 includes advertisers 104, publishers 102, and an ad network 108, in communication over a network 106. The publishers 102 may sell advertising space, referred to herein as impressions 112, to the ad network 108. The impressions 112 may be locations on web pages designated for advertising by the publishers 102.

When beginning an advertising campaign (ad campaign), advertisers 104 typically enter into contractual agreements, referred to herein as buys 116, with the ad network 108. The buy 116 specifies the terms under which the advertiser 104 compensates the ad network 108 for placing its ads on the impressions 112. The buys 116 may specify compensation based on cost per click (CPC), cost per action (CPA), some combination of CPC and CPA, or other terms.

A CPC based buy 116 may compensate the ad network 108 for each time a user clicks on the advertiser's ad. Because a simple click on an ad does not necessarily represent a sale to the advertiser, compensation based on CPC is typically nominal.

A CPA based buy 116 may compensate the ad network 108 for each time a user takes some action on behalf of the advertiser. For example, after clicking on the ad, the user may make a purchase at the advertiser's web site. Because the action represents a positive result for the advertiser 104, compensation based on CPA is typically higher than that for CPC terms. The action can be a sale, or some other activity specified in the buy 116. In some cases, the action may be a registration or activation process that the advertiser 104 provides to the users that click on the advertiser's ads.

The buy 116 may also specify cost and time limitations for the ad campaign. For example, the buy 116 may specify a budget cap and a budget period. The budget cap may specify a financial limit for the ad campaign. The budget period may specify beginning and end dates for the ad campaign. The term, buy 116, is used interchangeably with the term ad campaign herein.

The ad network 108 may build an inventory 110 of impressions 112, and organize the impressions 112 into impression segments 114. Impressions 112 and impression segments 114 are both referred to herein as placements. The impression segments 114 may be used to target advertising at a particular audience. For example, impression segments 114 may be classified according to demographic information. The impressions 112 may be classified according to the age, income, and gender groups that typically visit the web sites on which the impressions 112 advertise. Effectiveness of a buy may be enhanced by placing ads within appropriate impression segments 114. For example, placing the ads on web sites frequented by athletes may enhance an ad campaign for a health club.

The assignment of the buy 116 to the impression 112, or the impression segment 114 is referred to herein as a buy control placement (BCP). The buy 116 may be run on multiple placements. Additionally, each placement may display ads for multiple buys 116.

It should be noted that demographic classifications are merely an example of how impression segments 114 may be implemented. Other classification schemes are possible, depending on the particular implementation details of the ad network 108.

The buys 116 normally provide incentives for the ad network 108 to target the ads onto impressions 112 that enhance the ads' effectiveness. The ad network 108 may analyze the performance of the advertiser's ads to enable placing ads on impression segments 114 that enhance the effectiveness of the ads.

Typically, ad networks 108 test the effectiveness of the buy 116 on particular impression segments 114 by manually setting up a dedicated test budget period. Once the buy 116 is in the test budget period, the ads may be randomly allocated to different impression segments.

In some cases, this may occur even though there may be sufficient data to determine whether or not an impression segment 114 enhances the effectiveness of the tested ads. The typical approach wastes resources by testing ads that have already achieved data sufficiency.

Additionally, in traditional approaches, the dedicated test budget period does not account for changes in performance over the life of an ad campaign. As such, ads may become less effective without corrective action by the ad network 108.

In an embodiment, the buy 116 may be tested without a dedicated test budget period. Instead of an upfront budget test period, the ad network 108 may continuously monitor buys 116. With continuous monitoring, once the buy 116 is found to be lacking in data sufficiency, the ad network 108 may automatically allocate test impressions to the insufficient campaigns to ensure proper data sufficiency is maintained. Similar to typical approaches, continuous monitoring and maintaining data sufficiency may enable the ad network 108 to better predict the performance of ad campaigns in terms of click-through rate, conversion rate, and effective cost per thousand (eCPM).

In this way, resources may be reserved for testing ads that lack data sufficiency. Further, by maintaining data sufficiency over the course of an ad campaign, ads' effectiveness may be maintained, and even improved over the course of an ad campaign.

In another embodiment, the ad network 108 may balance the sufficiency gain and the opportunity cost when determining whether to randomly allocate ads. In this way, the revenue loss to the system 100 may be reduced in light of the value of the sufficiency that could be gained with a test, e.g., random, allocation.

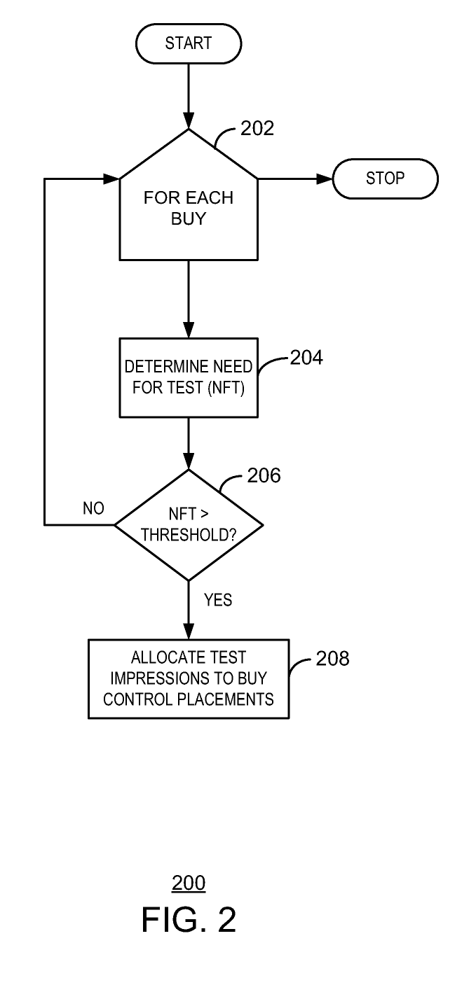

FIG. 2 is a process flow diagram of a method 200 for automatic testing of advertising campaign performance in accordance with the claimed subject matter. In one embodiment, the ad network 108 may perform the method 200. However, it should be understood that the process flow diagram is not intended to indicate a particular order of execution.

Blocks 202-208 may be performed for each buy 116 in the ad network 108. At block 204, a need for test (NFT) may be determined. The NFT may be a quantitative value that represents a level of need for the buy, in terms of data sufficiency and delivery status. For example, if an ad campaign is close to its budget period end, or has exhausted its budget already, there is no point to gain or maintain data sufficiency anymore regardless its data sufficiency.

In one embodiment, the NFT of each buy may be calculated from a weighted product of 1) percentage volume-based data sufficiency (DS), 2) percentage of data sufficient buy control placements (DSC), 3) percentage remaining days in the budget period (RD), and 4) percentage remaining budget under the budget cap (RB). The calculation of DS and DSC may use the eCPM category calculated in existing ad network systems.

In one embodiment, the data sufficiency may be calculated as follows:

DS=DATA SUFFICIENT PLACEMENT VOLUME FORECAST/TOTAL PLACEMENTS VOLUME FORECAST FORMULA 1

where the data sufficient placement may equal the sum of placements that have achieved data sufficiency, e.g., where the buy 116 is ESL (Estimation Sufficiency Level, or sufficiently good) or BAD (sufficiently bad). This may be based on a placement volume forecast. The total placements may represent the sum of all impressions 112 where the buy 116 is running

The DSC may be calculated as follows:

DSC=DATA SUFFICIENT BCP COUNT/TOTAL BCP COUNT FORMULA 2

Due to the possibility of data skew, determining data sufficiency merely based on volume may misrepresent data sufficiency for the whole buy 116. In such a scenario, the buy 116 may be data sufficient in terms of volume, but lacking in terms of total placements. Together, DS and DSC may capture a more meaningful representation of data sufficiency for the buy 116 rather than DS or DSC alone.

The remaining budget may be calculated as follows:

RB=(REMAINING BUDGET IN CURRENT BUDGET PERIOD+FUTURE BUDGET)/(BUDGET IN CURRENT BUDGET PERIOD+FUTURE BUDGET) FORMULA 3

The remaining days may be calculated as follows:

RD=(REMAINING DAYS IN CURRENT BUDGET PERIOD+DAYS IN FUTURE BUDGET)/(DAYS IN CURRENT BUDGET PERIOD+DAYS IN FUTURE BUDGET) FORMULA 4

In one embodiment, budget periods that are used for testing, unknown budget periods, or paused may be ignored in the calculation. If there is an unspecified end to the budget period, the RB and RD may be set to 100%.

The RB and RD may capture the delivery status of the buy 116 and help the ad network 108 make improved test decisions. For example, if the buy 116 has low data sufficiency, but has already spent its budget, further testing may provide no benefit because there is no revenue to gain (revenue delivered over advertiser budget cap cannot be billed). Similarly, the budget period is nearing completion, there may not be enough time to leverage any knowledge gained from additional testing. Hence, resources may be wasted if RB and RD are not considered in the calculus for determining the NFT.

As such, in one embodiment, the NFT may be calculated as follows:

NFT=(1-DS)^{a}*(1-DSC)^{b}*RB^{c}*RD^{d} FORMULA 5

where a, b, c, and d may be configurable parameters that reflect the relative importance to NFT of the corresponding factors. A higher NFT value may indicate that testing may be more useful than a lower NFT value. In one embodiment, the NFT value may be limited to a numerical range between 0 and 1. In this manner, if any of the four variables, (1-DS), (1-DSC), RB, and RD, is equal to 0, the NFT may be zero. A zero value NFT may indicate that testing is not useful.

To avoid the system spending overly large computational resources on buys that have low NFT values, a system wide configurable threshold, referred to herein as an NFT threshold, is provided. Continued processing may be performed for buys that have a NFT value greater than the threshold.

To avoid excessive testing of the buys, a specified threshold may be used to determine whether or not to test the buy 116. Accordingly, at block 206, the ad network 108 may determine whether the NFT exceeds the specified threshold.

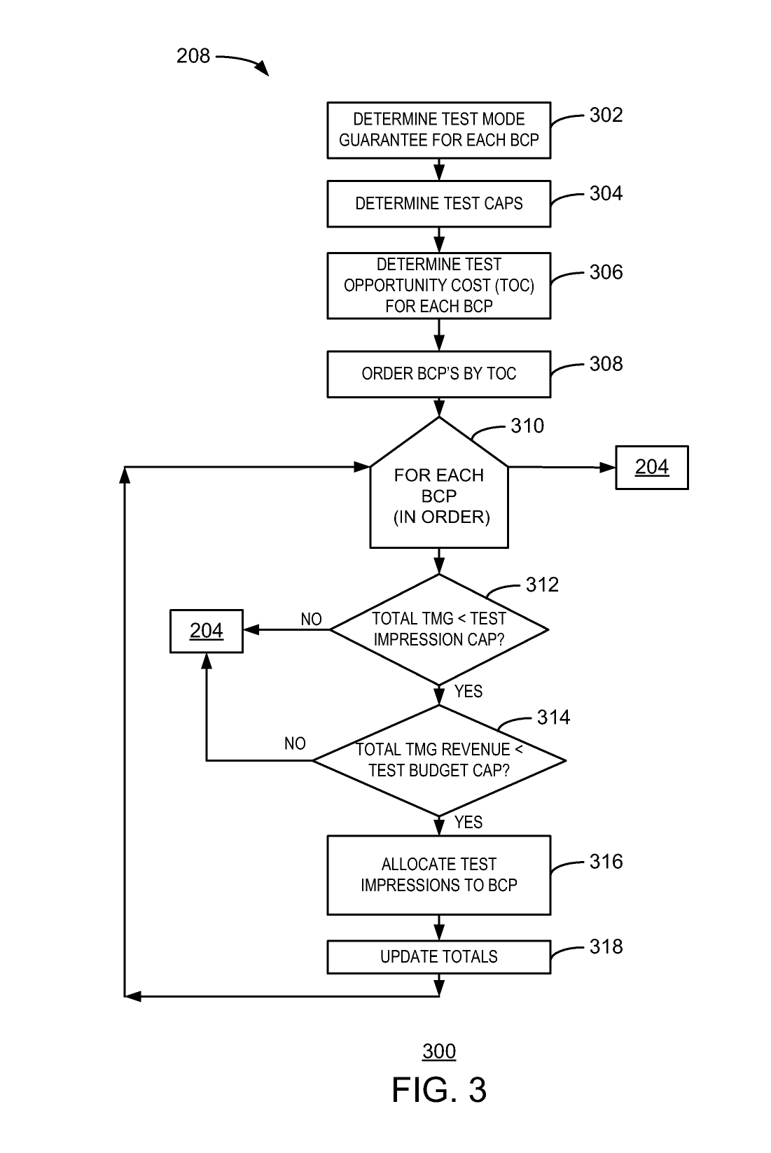

If the NFT does not exceed the specified threshold, the method 200 may flow to block 202 for the next buy 116. However, if the NFT exceeds the specified threshold, at block 208, the ad network 108 may allocate test impressions to buy control placements. The allocation of test impressions is described in greater detail with respect to FIG. 3.

FIG. 3 is a process flow diagram of the block 208 for allocating test impressions to buy control placements in accordance with the claimed subject matter. In one embodiment, the ad network 108 may perform the method 300. However, it should be understood that the process flow diagram is not intended to indicate a particular order of execution.

At block 302, the ad network 108 may determine a test mode guarantee for each buy control placement of the buy 116. The test mode guarantee may represent a number of test impressions that would meet a data sufficiency condition for the corresponding buy control placement.

At block 304, testing caps may be determined for the buy 116. The testing caps may represent a limit to the number of impressions, and how much budget may be used for testing the buy 116.

To avoid spending all available budget for the test, a test budget amount, or a number of test impressions may be limited. In one embodiment, the limit may be based on the NFT value. For example, the test budget cap may be calculated as follows:

TEST BUDGET CAP=DAILY BUDGET CAP*NFT FORMULA 6

The test impressions cap may be calculated as follows:

TEST IMPRESSIONS CAP=MIN(DAILY IMPRESSIONS CAP*NFT, TOTAL TMG*NFT) FORMULA 7

At block 306, a test opportunity cost may be determined for each buy control placement of the buy 116. The test opportunity cost may represent a cost incurred by randomly allocating test impressions. Randomly allocating test impressions may incur a cost because a buy control placement that is specifically targeted to achieve a level of effectiveness may have more value than the random placement.

At block 308, the buy control placements may be ordered by their test opportunity cost value. The order may be ascending. An ascending order may allow the ad network 108 to prioritize testing buy control placements with low test opportunity costs. In this manner, if testing is stopped due to the testing caps being met, the testing is limited to the buy control placements with the lowest test opportunity costs. Accordingly, blocks 310-318 may be repeated for each buy control placement in the sort order.

At block 312, the total test mode guarantees may be compared to the test impression cap. If the total test mode guarantees exceed the test impression cap, the test allocation may end for this buy 116. Accordingly, control may return to block 204 for the next buy 116.

At block 314, the total test mode guarantee revenue may be compared to the test budget cap. If the total test mode guarantee revenue exceeds the test budget cap, the test allocation may end for this buy 116. Accordingly, control may return to block 204 for the next buy 116.

At block 316, the ad network 108 may allocate test impressions to this buy control placement. At block 318, the totals may be updated. More specifically, the total test mode guarantees may be incremented by the test impressions allocated to the BCP, and the test mode guarantee revenue may be incremented by an estimation of revenue generated from the random allocation. Control may then flow back to block 310 for the next buy control placement.

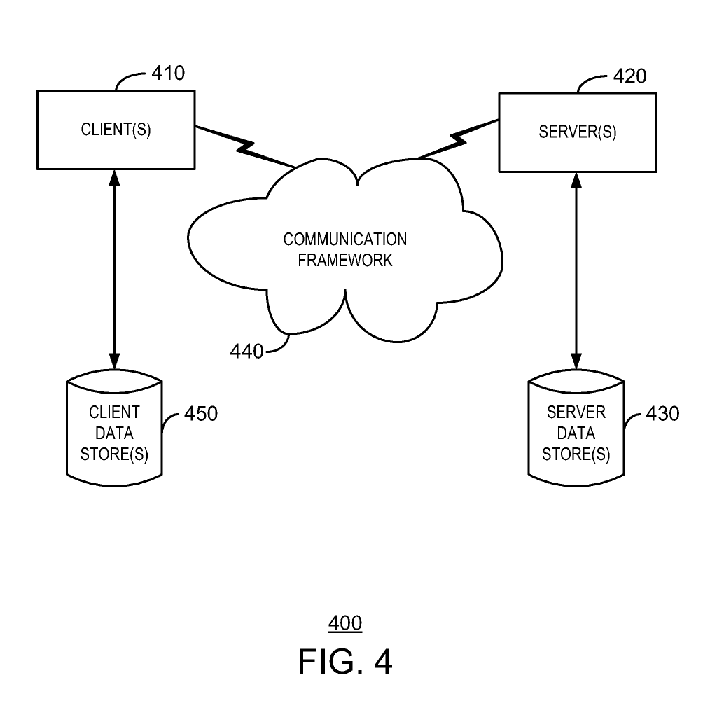

FIG. 4 is a block diagram of an exemplary networking environment 400 wherein aspects of the claimed subject matter can be employed. The networking environment 400 includes one or more client(s) 410. The client(s) 410 can be hardware and/or software (e.g., threads, processes, computing devices). The system 400 also includes one or more server(s) 420. The server(s) 420 can be hardware and/or software (e.g., threads, processes, computing devices). The servers 420 can house threads to automatically test the performance of advertising campaigns by employing the subject innovation, for example.

One possible communication between a client 410 and a server 420 can be in the form of a data packet adapted to be transmitted between two or more computer processes. The system 400 includes a communication framework 440 that can be employed to facilitate communications between the client(s) 410 and the server(s) 420. The client(s) 410 are operably connected to one or more client data store(s) 450 that can be employed to store information local to the client(s) 410. The client data store(s) 450 do not have to be in the client(s) 410, but may be located remotely, such as in a cloud server. Similarly, the server(s) 420 are operably connected to one or more server data store(s) 430 that can be employed to store information local to the servers 420.

As an example, the client(s) 410 may be computers providing access to ad network servers over a communication framework 440, such as the Internet. The server(s) 420 may be ad network servers accessed by the client.

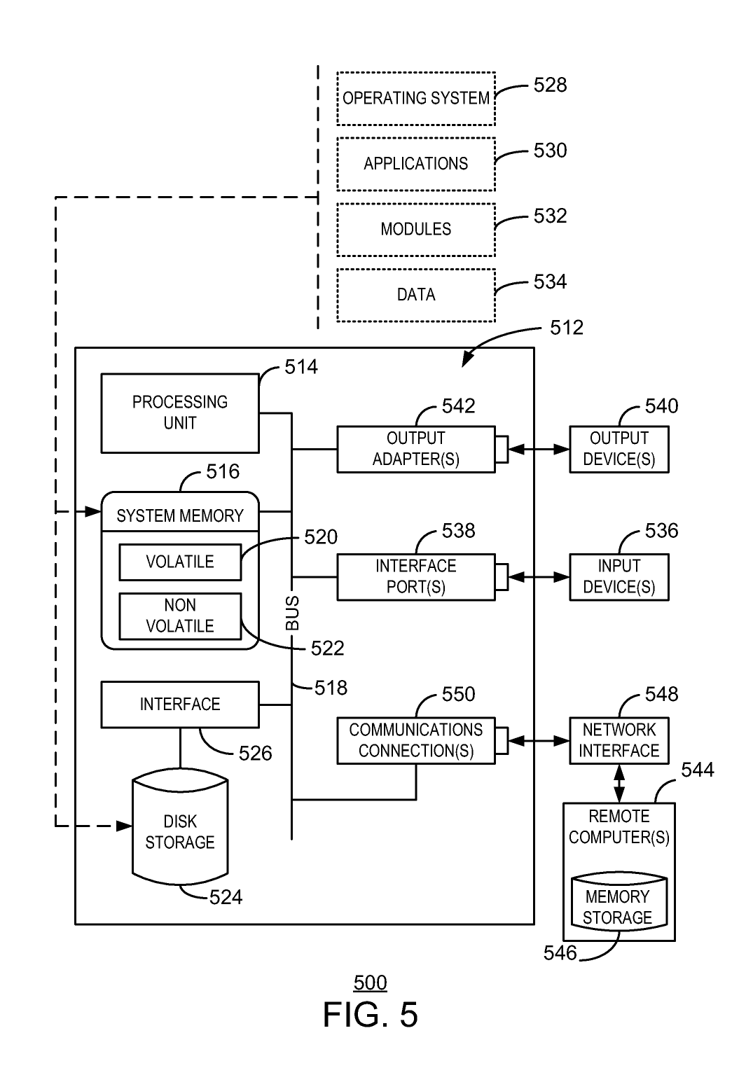

With reference to FIG. 5, an exemplary operating environment 500 for implementing various aspects of the claimed subject matter includes a computer 512. The computer 512 includes a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514.

The system bus 518 can be any of several types of bus structure(s) including the memory bus or memory controller, a peripheral bus or external bus, and/or a local bus using any variety of available bus architectures known to those of ordinary skill in the art.

The system memory 516 is non-transitory computer-readable media that includes volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), or flash memory.

Volatile memory 520 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 512 also includes other non-transitory computer-readable media, such as removable/non-removable, volatile/non-volatile computer storage media. FIG. 5 shows, for example a disk storage 524. Disk storage 524 includes, but is not limited to, devices like a magnetic disk drive, floppy disk drive, tape drive, Jaz drive, Zip drive, LS-100 drive, flash memory card, or memory stick.

In addition, disk storage 524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 524 to the system bus 518, a removable or non-removable interface is typically used such as interface 526.

It is to be appreciated that FIG. 5 describes software that acts as an intermediary between users and the basic computer resources described in the suitable operating environment 500. Such software includes an operating system 528. Operating system 528, which can be stored on disk storage 524, acts to control and allocate resources of the computer system 512.

System applications 530 take advantage of the management of resources by operating system 528 through program modules 532 and program data 534 stored either in system memory 516 or on disk storage 524. It is to be appreciated that the claimed subject matter can be implemented with various operating systems or combinations of operating systems.

A user enters commands or information into the computer 512 through input device(s) 536. Input devices 536 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 536 connect to the processing unit 514 through the system bus 518 via interface port(s) 538. Interface port(s) 538 include, for example, a serial port, a parallel port, a game port, and a universal serial bus (USB).

Output device(s) 540 use some of the same type of ports as input device(s) 536. Thus, for example, a USB port may be used to provide input to the computer 512, and to output information from computer 512 to an output device 540.

Output adapter 542 is provided to illustrate that there are some output devices 540 like monitors, speakers, and printers, among other output devices 540, which are accessible via adapters. The output adapters 542 include, by way of illustration and not limitation, video and sound cards that provide a means of connection between the output device 540 and the system bus 518. It can be noted that other devices and/or systems of devices provide both input and output capabilities such as remote computer(s) 544.

The computer 512 can be a server hosting an advertising network in a networked environment using logical connections to one or more remote computers, such as remote computer(s) 544. The remote computer(s) 544 may be client systems configured with web browsers, PC applications, mobile phone applications, and the like, to allow users to access the advertising network, as discussed herein. The remote computer(s) 544 can be a personal computer, a server, a router, a network PC, a workstation, a microprocessor based appliance, a mobile phone, a peer device or other common network node and the like, and typically includes many or all of the elements described relative to the computer 512. For purposes of brevity, only a memory storage device 546 is illustrated with remote computer(s) 544. Remote computer(s) 544 is logically connected to the computer 512 through a network interface 548 and then physically connected via a communication connection 550.

Network interface 548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 550 refers to the hardware/software employed to connect the network interface 548 to the bus 518. While communication connection 550 is shown for illustrative clarity inside computer 512, it can also be external to the computer 512. The hardware/software for connection to the network interface 548 may include, for exemplary purposes only, internal and external technologies such as, mobile phone switches, modems including regular telephone grade modems, cable modems and DSL modems, ISDN adapters, and Ethernet cards.

An exemplary embodiment of the computer 512 may comprise a server hosting an advertising network. The server may be configured to allocate advertising inventory as described herein. An exemplary processing unit 514 for the server may be a computing cluster comprising Intel® Xeon CPUs. The disk storage 524 may comprise an enterprise data storage system, for example, holding thousands of impressions. Exemplary embodiments of the subject innovation may automatically determine whether buys have a need for test. The subject innovation may allocate test impressions for each of the buy's buy control placements lacking data sufficiency.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for testing on-line advertising, comprising:
determining a need for test for an advertising campaign based on performance of the advertising campaign;
determining whether the need for test exceeds a predetermined threshold; and
allocating a test impression to a buy control placement of the advertising campaign based on the need for test.

2. The method of claim 1, wherein the need for test comprises a numeric value between 0 and 1 inclusively, wherein a numeric value of 0 indicates that there is not a need to test the advertising campaign, and wherein a numeric value of 1 indicates that there is the need to test the advertising campaign.

3. The method of claim 1, wherein the need for test comprises:
a data sufficiency of the advertising campaign;
a data sufficiency of a plurality of buy control placements of the advertising campaign;
an amount of remaining budget of the advertising campaign; and
an amount of remaining days of the advertising campaign.

4. The method of claim 3, wherein the need for test comprises (1-DS)^{a}*(1-DSC)^{b}*RB^{c}*RD^{d}, wherein:
DS comprises the data sufficiency of the advertising campaign;
DSC comprises the data sufficiency of the plurality of buy control placements of the advertising campaign;
RB comprises the amount of remaining budget of the advertising campaign;
RD comprises the amount of remaining days of the advertising campaign;
a comprises an importance of the DS to the need for test;
b comprises an importance of the DSC to the need for test;
c comprises an importance of the RB to the need for test; and
d comprises an importance of the RD to the need for test.

5. The method of claim 1, comprising:
determining an impression cap for a number of test impressions based on the need for test;
determining a budget cap for a budget for allocating the test impressions; and
allocating the test impressions based on the impression cap and the budget cap.

6. The method recited in claim 5, comprising determining a test opportunity cost for each of a plurality of buy control placements for the advertising campaign, wherein the test impressions are allocated to the plurality of buy control placements in ascending order of the test opportunity cost.

7. The method of claim 6, wherein allocating the test impressions comprises allocating an impression segment to each of a subset of the plurality of buy control placements.

8. The method of claim 5, wherein allocating the test impressions comprises allocating an impression to each of a subset of the plurality of buy control placements.

9. A system for testing on-line advertising, comprising:
a processing unit; and
a system memory, wherein the system memory comprises code configured to direct the processing unit to:
determine a need for test for an advertising campaign based on performance of the advertising campaign;
determine whether the need for test exceeds a predetermined threshold; and
allocate a plurality of test impressions to a plurality of buy control placements of the advertising campaign based on the need for test.

10. The system of claim 9, wherein the need for test comprises a numeric value between 0 and 1 inclusively, wherein a numeric value of 0 indicates that there is not a need to test the advertising campaign, and wherein a numeric value of 1 indicates that there is the need to test the advertising campaign.

11. The system of claim 9, wherein the need for test comprises:
a data sufficiency of the advertising campaign;
a data sufficiency of a plurality of buy control placements of the advertising campaign;
an amount of remaining budget of the advertising campaign; and
an amount of remaining days of the advertising campaign.

12. The system of claim 9, wherein the need for test comprises (1-DS)^{a}*(1-DSC)^{b}*RB^{e}*RD^{d}, wherein:
DS comprises the data sufficiency of the advertising campaign;
DSC comprises the data sufficiency of the plurality of buy control placements of the advertising campaign;
RB comprises the amount of remaining budget of the advertising campaign;
RD comprises the amount of remaining days of the advertising campaign;
a comprises an importance of the DS to the need for test;
b comprises an importance of the DSC to the need for test;
c comprises an importance of the RB to the need for test; and
d comprises an importance of the RD to the need for test.

13. The system of claim 9, wherein the system memory comprises code configured to direct the processing unit to:
determine an impression cap for a number of the plurality of test impressions based on the need for test;
determine a budget cap for a budget for allocating the plurality of test impressions; and
allocate the plurality of test impressions within the impression cap and the budget cap.

14. The system of claim 13, wherein the system memory comprises code configured to direct the processing unit to determine a test opportunity cost for each of the plurality of buy control placements for the advertising campaign, wherein the plurality of test impressions are allocated to the plurality of buy control placements based on the test opportunity cost.

15. The system of claim 14, wherein the code configured to allocate the plurality of test impressions comprises code configured to allocate an impression segment to each of a subset of the plurality of buy control placements, wherein the subset comprises the plurality of test impressions that are allocated within the impression cap and within the budget cap.

16. The system of claim 14, wherein the code configured to allocate the plurality of test impressions comprises code configured to allocate an impression to each of a subset of the plurality of buy control placements, wherein the subset comprises the plurality of test impressions that are allocated within the impression cap and within the budget cap.

17. A computer-readable medium, comprising code configured to direct a processing unit to:
determine a need for test for an advertising campaign based on performance of the advertising campaign;
determine whether the need for test exceeds a predetermined threshold;
determine a test opportunity cost for each of a plurality of buy control placements for the advertising campaign;
allocate a plurality of test impressions to a plurality of buy control placements of the advertising campaign based on the need for test, wherein the plurality of test impressions are allocated to the plurality of buy control placements in ascending order of the test opportunity cost.

18. The computer-readable medium of claim 17, wherein the need for test comprises:
a data sufficiency of the advertising campaign;
a data sufficiency of a plurality of buy control placements of the advertising campaign;
an amount of remaining budget of the advertising campaign; and
an amount of remaining days of the advertising campaign.

19. The computer-readable medium of claim 17, comprising code configured to direct the processing unit to:
determine an impression cap for a number of the plurality of test impressions based on the need for test;
determine a budget cap for a budget for allocating the plurality of test impressions; and
allocate the plurality of test impressions based on the impression cap and the budget cap.

20. The computer-readable medium of claim 19, wherein the code configured to allocate the plurality of test impressions comprises code configured to allocate an impression segment to each of a subset of the plurality of buy control placements.
